(19) United States
(12) Patent Application Publication
(10) Pub. No.: US 2016/0300137 A1
(43) Pub. Date: Oct. 13, 2016

(54) SYSTEM FOR THE COMPUTER-AIDED CREATION OF RULES FOR MONITORING AND/OR DIAGNOSING A TECHNICAL PLANT

(71) Applicant: SIEMENS AKTIENGESELLSCHAFT, München (DE)

(72) Inventors: Lisa Theresa Abele, München (DE); Stephan Grimm, München (DE); Michael Watzke, München (DE)

(73) Assignee: SIEMENS AKTIENGESELLSCHAFT, München (DE)

(21) Appl. No.: 15/037,366

(22) PCT Filed: Nov. 5, 2014
(86) PCT No.: PCT/EP2014/073777

§ 371 Date: May 18, 2016

(30) Foreign Application Priority Data
Nov. 21, 2013 (DE) 10 2013 223 833.9

(51) Int. Cl. G06N 5/02

(52) U.S. Cl. CPC G06N 5/022

(57) ABSTRACT

A system and method is provided for the computer-assisted creation of rules for monitoring and/or diagnosing a technical plant. The system includes a digital knowledge base in the form of a first ontology, including a plant ontology, which describes the technical plant, and a rule ontology, which includes rules, wherein a particular rule is linked by means of a condition relation to concepts in the form of one or more conditions, which refer to one or more concepts of the plant ontology, and is linked by means of a consequence relation to the concept of a consequence derived from the one or more conditions, which consequence refers to one or more concepts of the plant ontology.

### CROSS-REFERENCE TO RELATED APPLICATIONS

This application claims priority to PCT Application No. PCT/EP2014/073777, having a filing date of Nov. 5, 2014, based off of German application No. DE 102013223833.9 having a filing date of Nov. 21, 2013, the entire contents of which are hereby incorporated by reference.

### FIELD OF TECHNOLOGY

The following relates to a system for the computer-aided creation of rules for monitoring and/or diagnosing a technical plant, particularly an industrial plant, such as e.g. a manufacturing or production plant.

### BACKGROUND

Monitoring and diagnosis of technical plants requires, on the basis of the structure of the plant, the creation of a suitable monitoring and diagnosis system that, during operation of the plant, takes sensor signals or process information from the plant as a basis for detecting malfunctions and critical operating states and causes thereof.

The prior art discloses rule-based monitoring systems that are able to adapt their behavior on the basis of rules but that do not allow redundant rules to be identified or the consistency of rules to be checked or the rules to be analyzed in another way.

### SUMMARY

An aspect relates to providing a system for creating rules for monitoring and/or diagnosing a technical plant, in which a user is assisted in the drafting of rules in a simple and flexible manner and the rules can be automatically checked.

The system according to embodiments of the invention comprise a digital knowledge base in the form of a first ontology. Ontologies are sufficiently well known and represent semantic knowledge in the form of digital data. For this, ontologies use what are known as concepts or classes and relations between the concepts and also further constructs, such as inference and integrity rules for reasoning and for ensuring that said rules are valid. The first ontology comprises a plant ontology, which describes the technical plant on the basis of concepts and relations, and a rule ontology, which comprises rules as concepts and hence maps the structure of the rules. In this case, a respective rule is linked by means of a condition relation to concepts in the form of one or more conditions that refer to one or more concepts of the plant ontology. In addition, a respective rule is linked by means of a consequence relation to the concept of a consequence (e.g. a state) that is derived from the condition(s) and that refers to one or more concepts of the plant ontology. In other words, a respective rule derives a consequence in relation to a plant component when the condition(s) of the rule are met.

The system according to embodiments of the invention additionally comprise a user interface by means of which a user can alter the rule ontology by specifying rules (particularly instantiating rules), whereby the first ontology is edited. Furthermore, a reasoner is provided, reasoners for processing ontologies being inherently known. The reasoner is applied to a second ontology. The second ontology may be identical to the first edited ontology or be derived from the first edited ontology by means of an ontology transformation means. The reasoner verifies the rules in the second ontology and outputs the verification result via the user interface. The user is thus repeatedly provided with the opportunity to take the verification result from the reasoner via the user interface as a basis for making changes to the rules again and then returning them to the reasoner. The reasoner recognizes redundant, similar, conflicting and inconsistent rules, in particular, and these erroneous rules can then be eliminated by a user.

The system according to embodiments of the invention additionally comprise a rule generator in order to generate executable rules from the first edited ontology, which executable rules can be executed by a rule engine. In this way, rules are created that can subsequently be processed by means of the rule engine during operation of the technical plant, the rule engine being able to take the rules as a basis for recognizing and diagnosing critical states, fault states and the like for the technical plant. In this case, the execution of rules on the basis of rule engines is inherently known.

Embodiments of the invention are based on the insight that in a rule-based monitoring and diagnosis system, the rules can be represented on the basis of an ontology, which provides the opportunity for rules created by the user to be able to be automatically analyzed by means of a reasoner. This provides an improved system for creating user-specific rules that can subsequently be used to monitor and diagnose a technical plant during operation thereof.

In a particularly preferred embodiment, the first ontology is described on the basis of an ontology editor and is editable using the ontology editor. For example, the editor used can be Semantic Mediawiki, which is based on OWL/RDF. Semantic Mediawiki is an inherently known editor from the Semantic Web domain, which is based on web pages. This editor can be used in a particularly simple manner to provide a user interface for editing rules. If need be, the first ontology can also be described by means of other editors, such as e.g. Protege, however.

In a further preferred embodiment, the second ontology is implemented on the basis of the inherently known description language OWL (OWL—Ontology Web Language).

In a further variant of the system according to embodiments of the invention, the plant ontology comprises a structural ontology and a process ontology, wherein the structural ontology describes components of the plant and also the structural correlations thereof and the process ontology describes processes performed by the components of the plant. This allows the processes taking place during operation of a plant to be mapped in structured form in the ontology.

In a further embodiment, the system according to embodiments of the invention is embodied such that it first of all exports the edited first ontology, the exported ontology subsequently being converted into the second ontology using the ontology transformation means. In particular, the exported ontology is merged with a generic ontology in this case, the generic ontology containing axioms and concepts that are needed for the verification by the reasoner. The merging of ontologies and also the definition of a suitable generic ontology is in this case inherently known or lies within the scope of action of a person skilled in the art (see e.g. Bao, J. and Honavar, V., “Adapt OWL as a Modular Ontology Language”, in Proceedings of OWLED 2006 (Nov. 10-11, 2006)). Alternatively or additionally, the further ontology can be used by the rule generator to generate the executable rules.

In a further variant of the system according to embodiments of the invention, the user interface can additionally be used by a user to specify concepts and relations of the first ontology. This allows the system to be flexibly matched to any technical plants.

Preferably, the reasoner used in the system according to the invention is additionally embodied such that it classifies the concepts in the second ontology and outputs the classification result via the user interface. As a result, the user is provided with useful information about the technical plant and the processed rules, which he can then in turn take into account for editing the first ontology.

In a further embodiment of the system according to the invention, the user interface is embodied such that a user can direct queries to the second ontology, the query results being output via the user interface. In this case, queries are preferably processed in the inherently known query language SPARQL. According to this variant, the user can analyze the second ontology in a suitable manner on the basis of his requirements.

In a further, particularly preferred embodiment, the rule generation means or rule generator is embodied such that it first of all generates rules in the inherently known RIF-XML serialization syntax and subsequently translates the rules of this syntax into the executable rules of the format of the rule engine, appropriate translation algorithms being inherently known. In this case, the format of the rule engine is e.g. the Etalis format. This variant involves the performance of a conversion into the generic RIF format, which allows the system to be flexibly matched to different formats of different rule engines.

Embodiments of the invention additionally relate to a method for the computer-aided creation of rules for monitoring and/or diagnosing a technical plant by means of the system according to embodiments of the invention that are described above. In this case, a digital knowledge base in the form of a first ontology is provided, wherein the first ontology comprises a plant ontology, which describes the technical plant on the basis of concepts and relations, and a rule ontology, which comprises rules as concepts, wherein a respective rule is linked by means of a condition relation to concepts in the form of one or more conditions that refer to one or more concepts of the plant ontology, and is linked by means of a consequence relation to the concept of a consequence that is derived from the condition(s) and that refers to one or more concepts of the plant ontology. In addition, a user interface is provided by means of which a user can alter the rule ontology by specifying rules, whereby the first ontology is edited.

As part of the above method, a reasoner is applied to a second ontology, which is derived from the first edited ontology by means of an ontology transformation means or which is the first edited ontology, wherein the reasoner verifies the rules in the second ontology and outputs the verification result via the user interface. In addition, a rule generation means or rule generator generates executable rules from the first edited ontology, which executable rules can be executed by a rule engine.

All the preferred variants of the system according to embodiments of the invention that have been described above can also be implemented in a similar manner in the method according to embodiments of the invention that has been described above.

Embodiments of the invention furthermore relate to a method for monitoring and/or diagnosing a technical plant, wherein executable rules that have been or are created using the above-described system according to embodiments of the invention are executed by means of a rule engine during operation of the technical plant.

In addition, embodiments of the invention relate to an apparatus for monitoring and/or diagnosing a technical plant, wherein the apparatus is set up to carry out the above-described method for monitoring and diagnosing the technical plant.

Embodiments of the invention additionally comprise a computer program product having a program code, which is stored on a machine-readable storage medium, for performing the above-described method according to embodiments of the invention for creating rules and the above-described method according to embodiments of the invention for monitoring and/or diagnosing a technical plant when the program code is executed on a computer.

### BRIEF DESCRIPTION

Some of the embodiments will be described in detail, with reference to the following figures, wherein like designations denote like members, wherein:

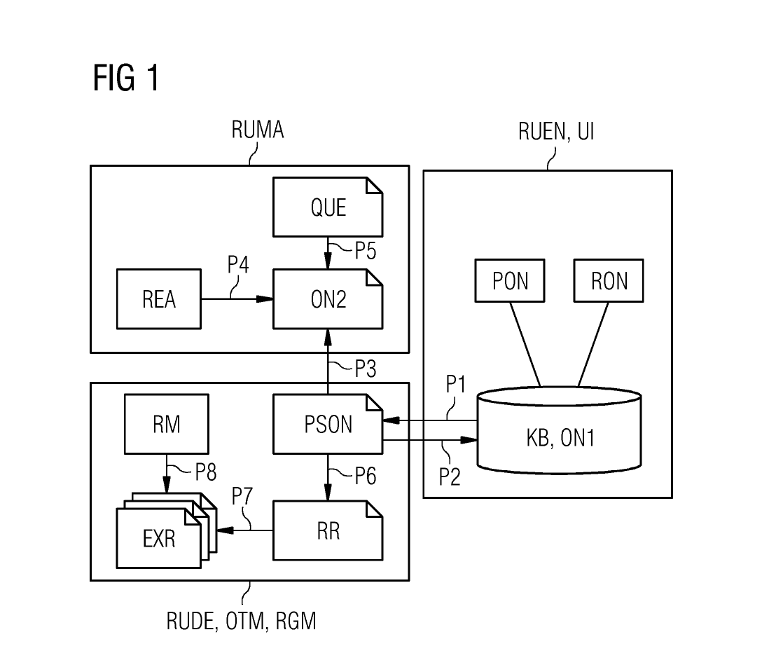

FIG. 1 shows a schematic illustration of an embodiment of the system for creating rules;

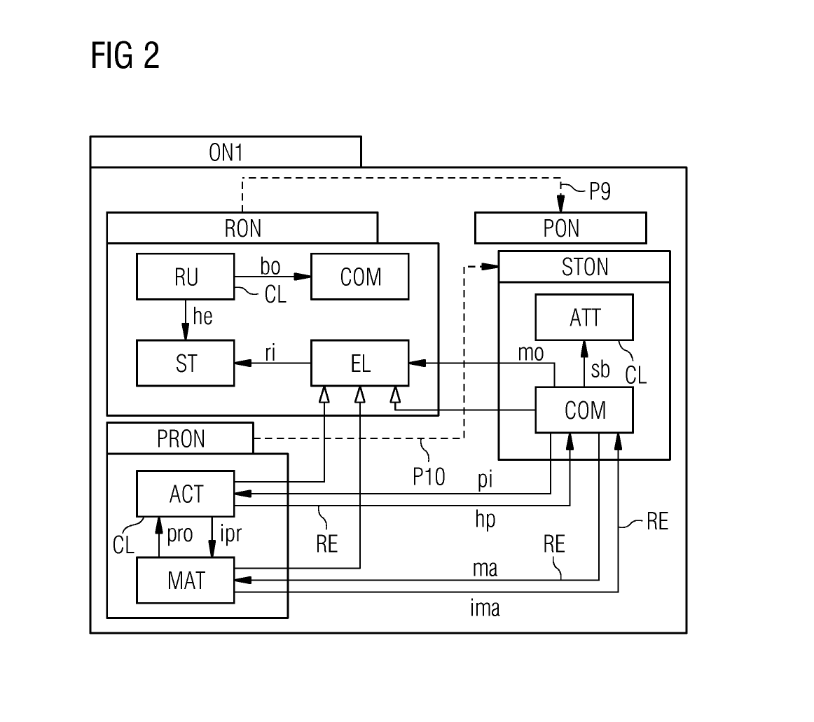

FIG. 2 shows a schematic illustration of the ontology contained in the knowledge base from FIG. 1;

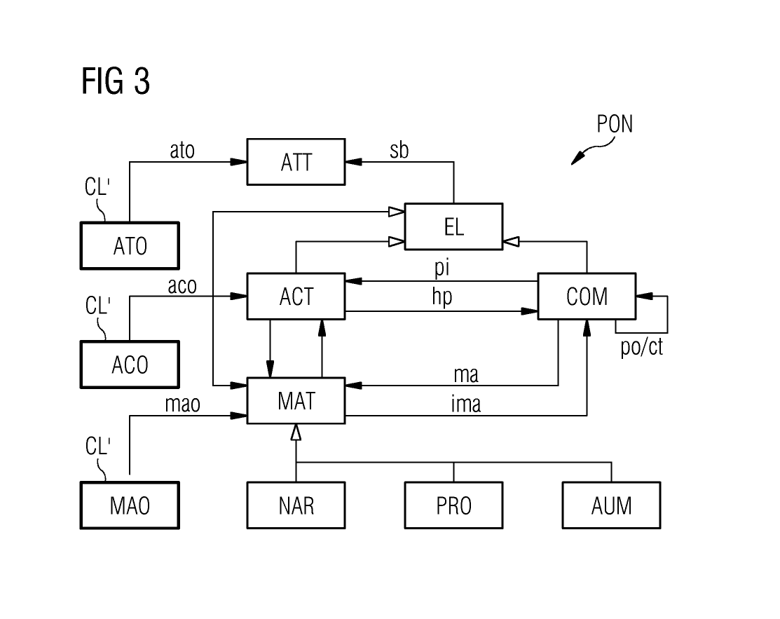

FIG. 3 shows a detailed illustration of the plant ontology contained in FIG. 2;

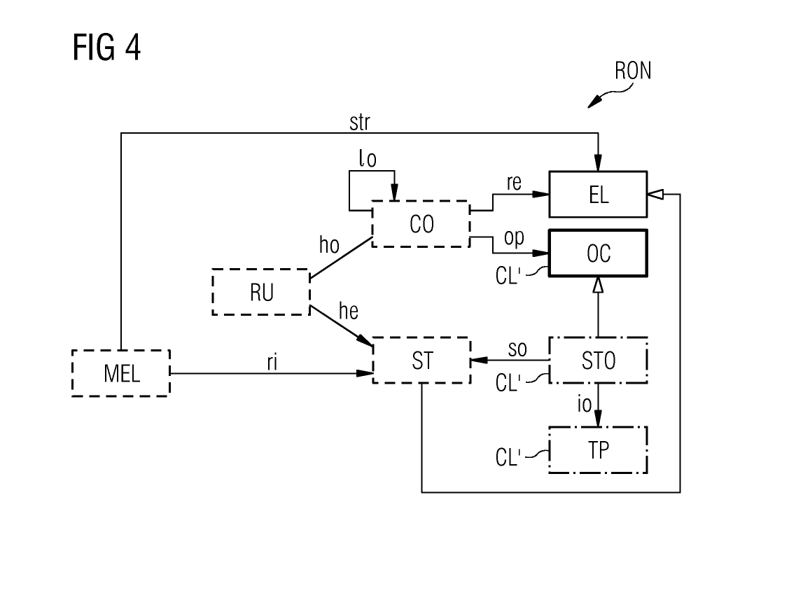

FIG. 4 shows a detailed illustration of the rule ontology contained in FIG. 2;

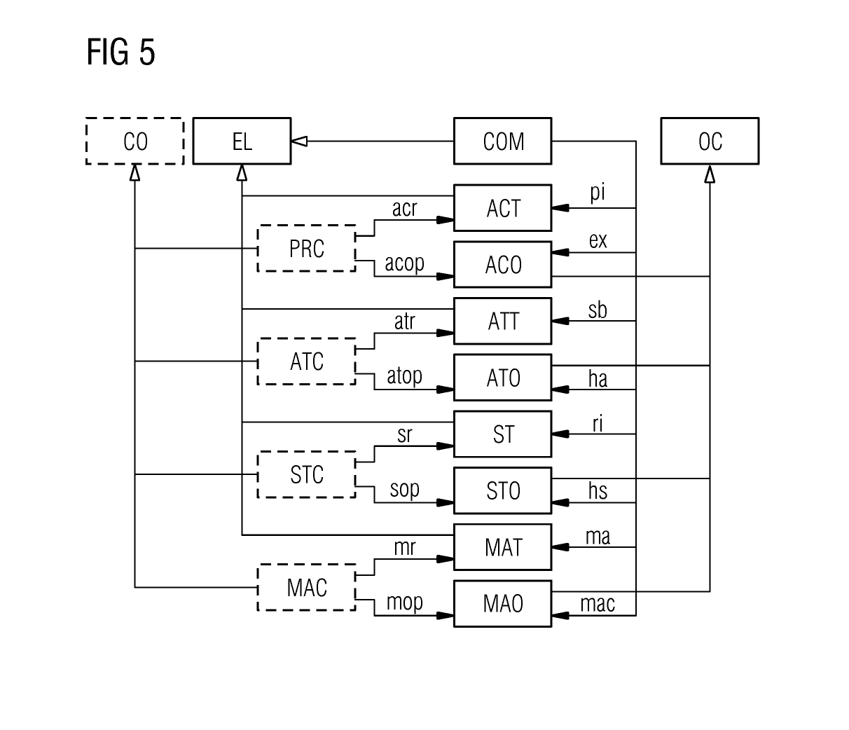

FIG. 5 shows a schematic illustration of a classification of the concept of the condition from the rule ontology of FIG. 4; and

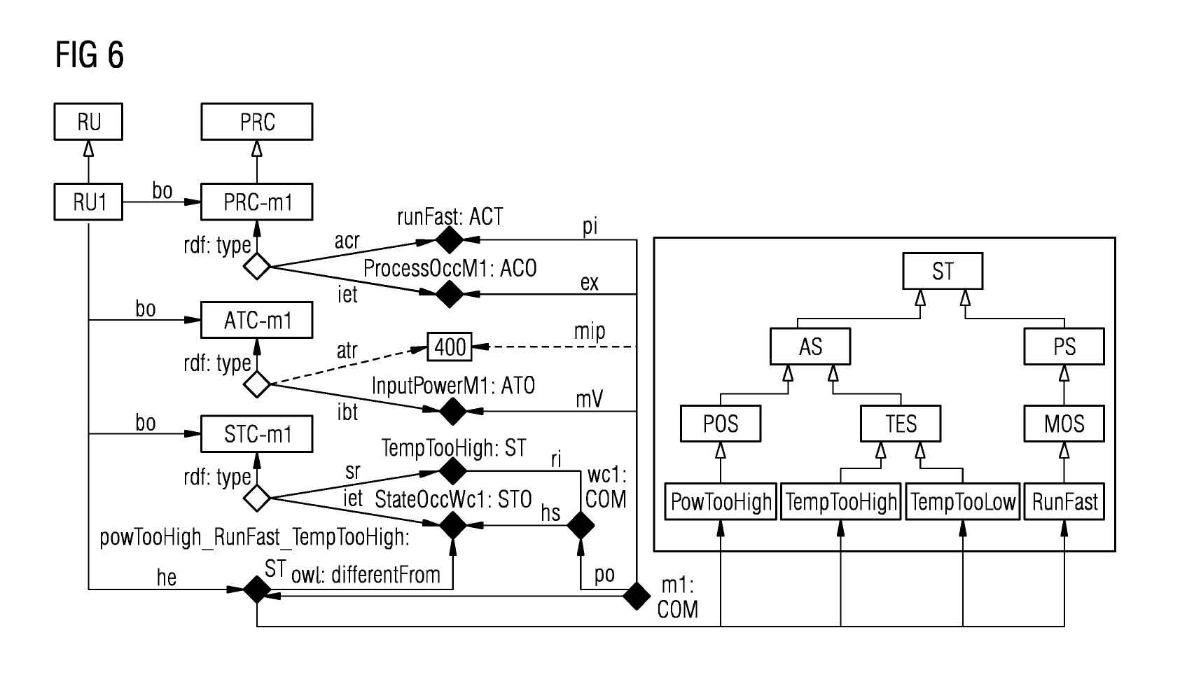

FIG. 6 shows a schematic illustration of an example of a rule that is contained in the ontology ON2 from FIG. 1.

The text below describes an exemplary embodiment of the invention based on the monitoring and diagnosis of a technical plant in the form of an industrial plant, which may be e.g. a production line or another plant for manufacturing products. Normally, the monitoring of an industrial plant comprises the derivation of equipment states of the industrial plant in order to schedule the maintenance of this equipment in a suitable manner. In addition, the monitoring in most cases also includes what is known as process monitoring, in which particular processes that are performed during operation of the plant are monitored in order to ensure that they are carried out correctly. In addition, the monitoring of an industrial plant normally also includes energy monitoring, which analyzes the present energy consumption of the plant in comparison with an expected energy consumption. The operators of an industrial plant therefore need to perform a multiplicity of different kinds of monitoring tasks. The embodiment described below provides a system in this regard that can be used to create, manage and execute appropriate rules for monitoring the plant in a simple and efficient manner.

### DETAILED DESCRIPTION

FIG. 1 shows a schematic illustration of an architecture that can be used to generate appropriate rules. The rules generated can be applied for the monitoring and, if need be, a diagnosis of a technical plant. The architecture comprises the component RUEN, which concerns the generation of appropriate rules by a user (what is known as rule engineering), the component RUMA, which concerns the further processing or management of the rules (what is known as rule maintenance), and the component RUDE, which concerns the implementation or use of the rules (what is known as rule deployment).

According to the embodiment in FIG. 1, a knowledge base KB in the form of a (first) ontology ON1 is provided. This ontology comprises a plant ontology PON and a rule ontology RON. In this case, a user interface UI is provided, which a user drafting the rules for monitoring and diagnosing the technical plant can use to edit the knowledge base or the first ontology by specifying or instantiating rules in the rule ontology RON. If need be, a user can also add concepts to the plant ontology or rule ontology. Examples of a plant ontology and a rule ontology are described in more detail further below. In this case, it is essential to embodiments of the invention that the knowledge base KB contains the rules themselves in turn as an ontology, which, for the further processing of the rules (component RUMA), allows these rules to be verified and classified in a suitable manner by means of a reasoner.

As is evident from the explanations above, it is therefore possible for a user, such as e.g. an engineer with knowledge about the plant, to store and edit his knowledge in the knowledge base KB in the form of an ontology library ON1. The knowledge base contains ontologies that assist the engineer in generating plant-specific ontologies thereon by editing the knowledge base. In this case, the user has the opportunity either to add additional concepts to the library or to map concepts onto already existing concepts in the library. This ensures that the knowledge base is flexible and adaptable.

In the embodiment described here, the knowledge base KB or the ontology ON1 is edited by using the inherently known editor “Semantic Mediawiki (SMW)”, which converts the ontology library into appropriate RDF models (RDF=Resource Description Framework) that allow a user to generate and edit structured knowledge about the plant in the form of web pages. In this case, Semantic Mediawiki assists experts in their task of modeling data from the plant and rules for monitoring and diagnosing the plant. In addition, Semantic Mediawiki allows the visualization and navigation in corresponding modeled data by means of the technical plant. The component RUEN and the associated interface UI therefore allow an expert to provide a more detailed specification of the technical plant on which the monitoring and diagnosis are based and to stipulate appropriate rules for monitoring and diagnosing the plant.

According to the embodiment in FIG. 1, the first ontology ON1 edited by the user is exported to a plant-specific ontology PSON that is based on the inherently known OWL/RDF specification (OWL=Ontology Web Language). This export can take place using Semantic Mediawiki by means of the special web page “Special:ExportRDF”. The export of the ontology is denoted by the arrow P1 in FIG. 1. In this case, there is also the opportunity for the exported ontology to be imported back into the knowledge base KB, which is indicated by the arrow P2. This is achieved by a script that converts OWL into the SMW syntax. A further feature of SMW is user guidance, which is achieved by templates and semantic forms, this allowing the explicit specification of rule templates for users.

An advantage of the use of Semantic Mediawiki is additionally that the cooperation of different experts who are familiar with different aspects of the plant is made possible. By way of example, manufacturers of components of the plant can specify general monitoring rules for these components, since they have in-depth knowledge that is needed for monitoring the components. A further advantage of Semantic Mediawiki is that firstly it provides an overview of all aspects of the monitored plant with navigation links, and secondly it is possible for specific aspects of the plant to be filtered using what are known as ASK queries.

In the embodiment in FIG. 1, the generated plant-specific ontology PSON is converted into a second OWL ontology ON2 using an ontology transformation means OTM, as indicated by the arrow P3. This ontology ON2 annotates the ontology PSON with appropriate axioms and concepts (also referred to as classes), which are needed for the further processing of rules in the component RUMA. In the further processing of the rules, this involves the use of what is known as a reasoner REA, reasoners for deriving knowledge from ontologies being inherently known. For example, the reasoner HermiT or Fact++ or Pellet can be used.

The reasoner REA is applied to the ontology ON2, as indicated by the arrow P4. In this case, the reasoner verifies the rules that the ontology ON2 contains by identifying semantically incorrect rules. In addition, it classifies the rules by arranging them in a structured taxonomy (i.e. classification). The corresponding verification and classification result is in turn output via the user interface UI. The user can then take the displayed result as a basis for correcting relevant conflicts in the original knowledge base or errors contained therein. In the embodiment in FIG. 1, there is additionally the opportunity for a user to direct queries QUE to the ontology ON2, as indicated by the arrow P5. This allows him to filter out e.g. reusable rules from the ontology.

According to the embodiment in FIG. 1, the rules are converted RUDE such that a rule generation means or rule generator RGM is used to translate the ontology PSON into what are known as RIF rules RR (see arrow P6). This involves all rule-related information from the ontology PSON being exported to a rule ontology, which is then converted into the RIF rules RR. RIF is an inherently known format that can be represented e.g. by the RIF-XML serialization syntax. This syntax is converted, using the rule generation means or rule generator RGM, by means of an inherently known method into executable rules EXR in a rule language format, which are then able to be executed by a rule engine RM. The conversion of the RIF rules RR into executable rules EXR is indicated by the arrow P7 in FIG. 1. In a specific embodiment, the executable rules are in this case based on the Etalis format. The relevant rule engine RM can then be used to execute these rules during real operation of the technical system (arrow P8).

As a result, it is possible for appropriate monitoring or diagnosis states of the technical plant and the components thereof to be derived, during operation thereof, on the basis of sensor data or process data using the executable rules. It is therefore possible for e.g. warnings to be output, provided that critical states arise during operation of the technical plant. Similarly, the executable rules can be used to obtain e.g. diagnosis data for the technical plant. The intermediate conversion of the rules into the RIF format increases the flexibility of the system, since the user can select a suitable rule engine on the basis of the plant-specific circumstances. If the system is intended to monitor e.g. realtime events, then it is possible to use a more complex CEP (Complex Event Processing) rule engine, such as e.g. Drools Fusion.

The ontologies PON and RON that the knowledge base KB contains are explained in more detail below. The ontologies described below are based in part on ontology patterns from known ontology sources. For example, they are based on the process specification language (PSL), which identifies, formally defines and structures semantic concepts in relation to the process performed by the plant. The plant ontology PON contains semantic knowledge about the specific plant, such as e.g. about connections between components in the plant or about products that are produced by the plant. By contrast, the rule ontology RON contains rules for recognizing states in the plant, such as e.g. a rule for deriving the state “powerTooHigh” (i.e. excessively high electric power) for a motor m1 in the plant.

The plant ontology PON in the embodiment described here is additionally split again into a structural ontology STON and a process ontology PRON (FIG. 2). The structural ontology defines different kinds of fundamental information. Firstly, a component taxonomy is stipulated, which identifies and names classes of components and arranges them in a hierarchy. In addition, the structural ontology describes the topology of the plant, which is achieved by means of a hierarchy that stipulates which components are contained in other components. To this end, the “part-of” (po for short) relation described later on is used and also other relations, which are likewise described later on. Furthermore, the structural ontology defines properties of components by means of attributes. The namespace of the structural ontology is “pi”.

The process ontology PRON specifies the material that is processed by activities of the plant and manipulated by components of the plant throughout the production process. The namespace of the process ontology is “pr:”.

In contrast to the above ontologies STON and PRON, the rule ontology RON uses concepts that are needed in order to specify fundamental rules for recognizing states of the monitored elements of the other ontologies. This rule ontology is an essential part of the system according to embodiments of the invention, since it is needed in order to create the rules and process them further. The namespace of the rule ontology is “mon:”.

FIG. 2 shows a UML diagram that shows an embodiment of an ontology ON1 used in the system according to the invention. As mentioned above, this ontology comprises the plant ontology PON and the rule ontology RON. The plant ontology is made up of the structural ontology STON and the process ontology PRON. In a manner that is inherently known, the diagram in FIG. 2 and also further figures show relations RE by means of arrows with black tips. For reasons of clarity, only some of the relations are provided with the reference symbol RE. By contrast, arrows with white tips characterize class relationships, i.e. the concept at which an arrow with a white tip ends is a superordinate concept for the concept at which the arrow has its origin. The blocks in FIG. 2, which are not ontologies, represent the classes or concepts, only some of which are provided with the reference symbol CL for reasons of clarity. The arrows with dashed lines P9 and P10 additionally indicate that the ontology RON uses the ontology PON and the ontology PRON uses the ontology STON. The structural ontology STON contains attributes ATT and components COM of the plant as concepts. The process ontology PRON contains activities ACT and material MAT as concepts. The rule ontology RON contains rules RU, states ST, conditions CO and elements EL as concepts. The following relations are contained in the ontology ON1 of FIG. 2:
Relation sb (=specified-by), which stipulates which attribute ATT specifies a component COM;
Relation mo (=monitors), which stipulates which element EL is monitored by the component COM;
Relation pi (=participates-in), which stipulates in which activity ACT a component COM is involved;
Relation hp (=has-participant), which stipulates which component COM is involved in an action ACT;
Relation pro (=processes), which stipulates which activity ACT processes a material MAT;
Relation ipr (=is-processed), which stipulates which material MAT is processed by an activity ACT;
Relation ma (=manipulates), which stipulates which component COM processes a material MAT;
Relation ima (=is-manipulated-by), which stipulates which material MAT is manipulated (processed) by a component COM;
Relation bo (=body), which corresponds to an if relation and stipulates a condition CO of the relevant rule RU;

Relation he (=head), which corresponds to a then relation and stipulates which state ST arises
on the basis of the rule RU when the condition CO specified by means of the relation bo arises;
Relation ri (=resides-in), which stipulates which state ST is adopted by an element EL.

Specifically, the plant ontology PON of FIG. 2 contains the concepts (=classes) described in the table below with a corresponding (informal) definition. Not all these concepts are shown in FIG. 2.

| Concept | Definition |
|---|---|
| Element EL | Central concept of this ontology, which concept comprises all the |
| | objects of a plant. |
| Activity ACT | An action that is defined in the process ontology, e.g. “m1RunFast” |
| | corresponds to the class of actions in which a motor m1 moves an |
| | object quickly. |
| Activity occurrence | An action that is instantiated at a specific location and a specific |
| ACO | time, e.g. “m1RunFast is executed by motor m1 at 14:00 hours on |
| | May 25, 2013” corresponds to the occurrence of the activity |
| | “m1RunFast”. |
| Component COM | This concept describes an individual or composite component in the |
| | plant. The components can participate in activities by means of the |
| | relation pi. Each plant is made up of multiple components, e.g. the |
| | component “motor m1” is part of the work cell 1. |
| Material MAT | A class of the material is manipulated by components in the plant by |
| | means of the relation ima and processed by activities by the relation |
| | pro. The material class is either a natural resource NAR, a product |
| | PRO or an auxiliary material AUM. An |
| | example of a natural resource is energy. |
| Material occurrence | This class denotes material that is processed in a plant at a specific |
| MAO | location and at a specific time, e.g. “a part of a vehicle that is |
| | transported by means of a conveyor belt at 14:00 hours on Jun. 24, |
| | 2013”. |
| Attribute ATT | The attribute class is used to specify properties of elements or |
| | components, e.g. a component can comprise attributes such as |
| | “maximum input power = 400 W”. |
| Attribute occurrence | This class describes a property of an element that is instantiated at a |
| ATO | particular time, e.g. “a motor m1 has the input power of 500 W at |
| | 14:00 hours on May 25, 2013”. |

FIG. 3 again shows a detailed illustration of the above-described plant ontology PON in the form of a UML diagram. Besides the classes and relations already contained in FIG. 2, the following further classes and relations are also shown:
The class ATO, which corresponds to the attribute occurrence described above;
the class ACO, which corresponds to the activity occurrence described above;
the class MAO, which corresponds to the material occurrence described above;
the class NAR, which corresponds to the natural resource described above;
the class PRO, which corresponds to the product described above;
the class AUM, which corresponds to the auxiliary material described above;
the relation ato (=attribute-occurrence-of), which specifies which attribute ATT occurs in the class ATO;
the relation aco (=activity-occurrence-of), which specifies which activity ACT occurs in the class ACO;
the relation mao (=material-occurrence-of), which specifies which material MAT occurs in the MAO;
the relation po/ct (=part-of/connected-to), which specifies the superordinate component of which the component COM is part or to which component the component COM is connected.

Some of the concepts of the plant ontology described above are based on ontology patterns from available ontology sources, such as e.g. the concepts “activity” and “activity occurrence”, with corresponding axioms from the PSL ontology. All other concepts have been extracted by virtue of different production plants having been analyzed, known standards in the field of manufacture (e.g. CAEX for a plant structure) having been checked and interviews with experts having been conducted. Some concepts of the plant ontology PON shown in FIG. 3 are instantiated only at the runtime of the plant. These concepts are additionally denoted by the reference symbol CL′ in FIG. 3 and relate to the classes attribute occurrence ATO, activity occurrence ACO and material occurrence MAO. These concepts are modeled as wild cards with standard names, so that they can be represented and referenced by other concepts in the ontology. All the properties of the plant ontology shown in FIG. 3 represent a subproperty of the relation structural-relation, which is denoted by the reference symbol str in FIG. 4, which is described later on.

The table below shows concepts that are contained in the rule ontology RON.

| Concept | Definition |
|---|---|
| Monitored element | Central concept of this ontology, which comprises all the elements |
| MEL | EL of a plant that are able to be monitored. This is either an activity, |
| | a component or a material. |
| Rule RU | A rule is used in order to derive a state ST for a monitored element |
| | EL on the basis of one or more monitored conditions CO. |
| Condition CO | A condition needs to be met in order to trigger a rule. A condition is |
| | met when a specific operator (e.g. “equal to”) is present between an |
| | element EL, which is connected to the condition by means of the |
| | relation re (=reference), and an occurrence OC (described later on). |
| | Different monitored conditions may be linked by logic operators, |
| | such as e.g. OR or AND. |
| State ST | A class of states that contains a monitored element. By way of |
| | example, a state may be defined as “energy consumption too high”. |
| State occurrence STO | An occurrence of a state. For example, “energy consumption of the |
| | motor ml is too high at 14:00 hours on May 25, 2013” is a state |
| | occurrence of the state “energy consumption is too high”. |
| Occurrence OC | A supertype of all objects that are instantiated during operation of the |
| | plant. |
| Time TP | A specific time. |

The concepts and relations explained in the table above are presented again in detail in FIG. 4. In this case, the concepts and relations are denoted as follows:
RU corresponds to the concept of a rule that is explained above;
CO corresponds to the concept of a monitored condition that is explained above;
ST corresponds to the concept of a state that is explained above;
EL corresponds to the concept of an element that is explained above;
OC corresponds to the concept of an occurrence that is explained above;
STO corresponds to the concept of a state occurrence that is explained above;
TP corresponds to the concept of a time that is explained above;
MEL corresponds to the concept of a monitored element that is explained above;
lo (=logical operator) corresponds to a logic operator, such as AND or OR;
re (=reference) corresponds to the relation “reference” that is explained above, and refers to an element EL;
op (=operator) corresponds to the relation “operator” and refers to an occurrence OC;
so (=state-occurrence-of) corresponds to the relation of the occurrence of a state;
io (=is-occurring-at) corresponds to the relation of the occurrence of a state at a particular time.

The further relations, contained in FIG. 4, have already been described above. Again, the classes CL′ denote concepts that are instantiated during the runtime of the plant.

The rule ontology shown in FIG. 4 can be used to verify the correct structure of rules during drafting thereof. In this case, it is essential to embodiments of the invention that not only the knowledge about the technical plant but also the rules are recorded in the form of ontologies. Prior to the specification of a rule for a specific monitored element m1 (m1 denotes a motor) via the user interface UI, an expert may look for information about m1 that is stored in the plant ontology. For example, the user can look for the attribute “powerM1” or the process “RunFast” that are connected to m1. In this case, the attribute “powerM1” denotes the power at which the motor is operated. During the definition of a rule, the expert can select all elements that are related to the component m1, particularly the aforementioned attributes and processes “powerM1” and “RunFast”. On the basis of this, he can then specify a rule, such as e.g. the rule RU1, which is shown in FIG. 6, described later on. The system can then use an axiom to verify different guidelines, e.g. by means of an axiom that states that all monitored conditions that are linked to a rule (in this case RU1) by means of the relation lo can have only one relation structural-relation (str) to the objects to which the monitored element (in this case m1) relates.

In addition, a user can use the concepts of the rule ontology in order to manually construct taxonomies for states, monitored conditions or rules. Such taxonomies have different advantages. Firstly, a higher level of reusability of the monitored rules is achieved on the basis of the common information structures when new rules are drafted by the user. Secondly, the cooperation between different experts is facilitated, since the automatic selection of objects having identical meanings is simplified.

FIG. 5 shows a schematic illustration of a possible extension of the ontology shown in FIG. 4, with a taxonomy for the monitored condition CO being formed. Specifically, the class of the monitored condition CO contains the subclasses PRC (process condition), ATC (attribute condition), STC (state condition) and MAC (material condition). These conditions are linked to subclasses of the element class EL and the occurrence class OC, namely the classes ACT, ACO, ATT, ATO, ST, STO, MAT, MAO, which have already been described above. These subclasses are linked to the class COM by means of suitable relations, namely the relations pi, ex, sb, ha, ri, hs, ma, mac. Apart from the relations ex, ha, hs and mac, all the cited relations have already been explained above. The relation ex (=executes) means that the component COM executes the activity occurrence ACO. The relation ha (=has-attribute) means that the component COM has the attribute ATO. The relation hs (=has-state) means that the component COM has the state STO. The relation MAC means that the component COM processes the material occurrence MAC. The individual classes PRC, ATC, STC and MAC have relations having the said subclasses of the element class EL and the occurrence class OC. In this case, the relations acr, acop, atr, atop, sr, sop, mr and mop are used.

The meaning of these relations is as follows:

acr (=activityRef) is a reference re to an activity ACT;
acop (=activity Op) is an operator op for an activity occurrence ACO;
atr (=attributeRef) is a reference re to an attribute ATT;
atop (=attributeOp) is an operator op for an attribute occurrence ATO;
sr (=stateRef) is a reference re to a state ST;
sop (=stateOp) is an operator op for a state occurrence STO;
mr (=materialRef) is a reference re to a material MAT;
mop (=materialOp) is an operator op for a material occurrence MAO.

The ontology shown in FIG. 5 allows the rule ontology to be extended to different technical domains by adding domain-specific classes. For example, the condition “temperature of m1 greater than 40° C.” is now represented, according to FIG. 5, by the attribute condition subclass ATC whereas “activity occurrence of m1=average speed” is specified by the process condition subclass PRC. Similarly, FIG. 5, for example, reveals that the process condition PRC is a subclass of the monitored condition CO.

FIG. 6 illustrates an example of a rule RU1 in relation to the motor m1, that is instantiated in the knowledge base KB in FIG. 1 by means of the user interface UI. In this case, the rule contains the process condition PRC-m1, the attribute condition ATC-m1 and the state condition STC-m1. The illustration in FIG. 6 is sufficiently well known to a person skilled in the art and is based on OWL. In this case, rectangular boxes denote OWL classes, black diamonds denote OWL individuals, white diamonds denote anonymous OWL individuals, solid arrows denote OWL object properties and dashed arrows denote OWL data type properties. FIG. 6 contains the type declarations RDF:type and the inherently known relation differentFrom from the OWL namespace. In addition, the component wc1 denotes the work cell 1, and there exist the activity occurrence ProcessOccM1, the attribute occurrence InputPowerM1, the state TempTooHigh and the state occurrence StateOccWc1. Furthermore, the state powTooHigh_RunFast_TempTooHigh exists. In addition, iet (=isEqualto) and ibt (=isBiggerthan), which are subtypes of the “operation” relation, are included as new relations that have not yet been described. In addition, the relation io (=instance-of) denotes a corresponding instantiation in the RDF syntax, the relation my (=measured-value) is a measured value and the relation mip denotes the maximum input power.

Furthermore, FIG. 6 shows a taxonomy for states that is able to be stipulated by a user using the user interface UI from FIG. 1. In this case, PowTooHigh denotes the state in which the power of the motor m1 is too high, TempTooHigh denotes the state in which the temperature of the motor m1 is too high and TempTooLow denotes the state in which the temperature of the motor m1 is too low. As already mentioned above, RunFast denotes the state of a motor running quickly. The state PowTooHigh is a subclass of the power state POS. The states TempTooHigh and TempTooLow are subclasses of the temperature state TES. The states POS and TES are in turn subclasses of the attributes state AS, which is in turn a subclass of the state ST. The state RunFast is a subclass of the motor state MOS, which is a subclass of the process state PS, which is in turn a subclass of the state ST.

The rule shown in FIG. 6 states the following: “If a motor m1 carries out an activity that corresponds to the activity RunFast, and the measured value of the input power is greater than 400 and m1 is a part of the component of the work cell 1 with the identity wc1, which is currently in a state TempTooHigh in which the temperature is too high, then the state of the motor m1 is set to PowTooHigh_RunFast_TempTooHigh, which means that the energy consumption and the ambient temperature of the motor are too high during the RunFast process.

The text below describes how the reasoner REA shown in FIG. 1 can be used to verify rules from the ontology ON2. Usually, various experts are involved in the implementation of rules using the system of FIG. 1. These experts define rules in order to specify individual monitored states of monitored elements of the plant. During the drafting of the rules or later adaptations, redundant, conflicting or inconsistent rules can occur. In the system of FIG. 1, such rules can be identified by means of the reasoner REA.

By way of example, a verification is explained according to which two conflicting rules are identified. Two rules are in conflict when they derive two different states even though they have the same conditions as an input. If a rule Rule1 derives the state TempTooHigh and a rule Rule2 derives the state TempTooLow, for example, even though both rules relate to the same condition, then such an inconsistency is recognized by a suitable OWL-DL reasoner, such as e.g. Pellet. A further example of a verification task is the identification of rules that can never be executed. This is the case, for example, when rules use inverse monitored conditions. This arises when a rule contains the two conditions “temperature of m1 greater than 20° C.” and “temperature of m1 less than 20° C.”, for example. Such inverse conditions within a rule are also recognized by means of a suitable reasoner.

The reasoner REA used in FIG. 1 can additionally also perform a classification. In this case, inherently known classification mechanisms are used by OWL reasoners in order to structure the rules RU and the monitored conditions CO into different classification hierarchies or taxonomies. The classification can be used to structure rules by identifying subtypes of monitored conditions. In general, a rule Rule1 can be classified as a subtype of another rule Rule2 if the rule Rule1 uses the subset of the conditions CO of the rule Rule2. An example of an implementation of this classification task is as follows: if the rule Rule1 from FIG. 6 has three conditions, whereas another rule Rule2 has only two of these conditions, then the rule Rule1 is classified as a subtype of the rule Rule2 by an OWL reasoner. According to the classification task, it is also possible for redundant rules to be identified. In this case, the reasoner checks whether some rules in the rule ontology have equivalent conditions and deduce the same states. These rules are then categorized as equivalent by the reasoner.

As is evident from FIG. 1, it is additionally possible for queries QUE to be directed to the ontology ON2 by a user. In one specific embodiment, SPARQL queries are processed in this case. For example, a user may wish to replace all motors of type M1FK7 in the plant with new motors of type M1PH8 having lower energy consumption. He can then use an appropriate query in the ontology ON2 to identify all rules that contain the motor of M1FK7 and relate to the power consumption POS. In this case, the taxonomy of states that is shown in FIG. 6 can be used within this query. Queries can additionally be used to filter meta information and for data analysis.

The conversion of the knowledge base KB or ontology ON1 into executable rules EXR that is shown in FIG. 1 can be described as a workflow. In the workflow, both the plant ontology PON and the rule ontology RON are defined by means of Semantic Mediawiki. These ontologies form the knowledge base KB, which is then converted into the plant-specific OWL ontology PSON by means of an export. From this ontology, the ontology ON2 is then derived, which is then validated by means of the reasoner. Repeated editing of the original ontology ON1 and validation of the ontologies ON2 derived therefrom finally create a consistent ontology. To use the latter, the rules in the ontology PSON are mapped onto the generic format RIF. That is to say that the rules are translated into the RIF-XML serialization syntax. In this case, the translation is effected by means of XSLT using a suitable XSL stylesheet. From this, the RIF-XML serialization syntax is then obtained on the basis of the map that is defined in the W3C RIF standard. To generate the RIF rules, an XSLT processor, such as e.g. Saxon, is used, which is parameterized using an XSL stylesheet that contains the XSLT translation specific to the RIF-XML syntax. The XSL stylesheet consists of a number of XML templates that identify matching XML structures and specify suitable RIF-specific code fragments into which the XML structures are translated.

Finally, the RIF rules are converted into specific rules in the language format of a rule engine RM by means of XSLT. During the XSLT processing, matching XML structures are ascertained in this case and translated into rule code fragments. Finally, executable rules are obtained by means of the relevant rule engine. In one specific embodiment, the executable rules are based on the rule language Etalis.

As a result of the system described above, suitable executable rules are finally obtained that are denoted by EXR in FIG. 1. In the course of the operation of the technical plant for which the rules have been drafted, a rule engine RM is then started up with these rules. In this case, the rule engine processes relevant states of the technical plant that are sensed e.g. by means of sensors. As a result, the rule engine then generates monitored events and annotates them using machine-readable semantics. The events can be either displayed to a user via an interface or processed by further modules (e.g. a diagnosis module).

The embodiments of the invention that are described above have a series of advantages. In particular, simple and efficient creation of rules for a technical plant is achieved by means of a user interface, the rules also being presented as ontologies, in contrast to the prior art. This allows knowledge-based reasoning and query mechanisms to be used to check the rules, and particularly verify and classify them, in a suitable manner. The result of the check can be presented to the user, who can then make adjustments to the created rules in the event of inconsistencies in the rule base. The system according to embodiments of the invention additionally allows automatic conversion of the rules from the ontology into suitable executable rules of a rule engine, which can then be used to monitor or diagnose the technical plant in a simple and efficient manner.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A system for the computer-aided creation of rules for at least one of monitoring and diagnosing a technical plant, comprising a digital knowledge base in the form of a first ontology, including a plant ontology, which describes the technical plant on the basis of concepts and relations, and a rule ontology, which comprises rules as concepts, wherein a respective rule is linked by a condition relation to concepts in the form of one or more conditions, wherein the condition or conditions refer to one or more concepts of the plant ontology and wherein a respective rule is linked by a consequence relation to the concept of a consequences that is derived from the one or more conditioner and that refers to one or more concepts of the plant ontology; —a user interface by means of which a user can alter the rule ontology by specifying rules, whereby the first ontology is edited; —a reasoner that, during operation, is applied to a second ontology, which is derived from the first edited ontology by means of an ontology transformation means or which is the first edited ontology, wherein the reasoner verifies the rules in the second ontology and outputs the verification result via the user interface; —a rule generator which generates executable rules from the first edited ontology, which executable rules can be executed by a rule engine.

2. The system as claimed in claim 1, wherein the first ontology is described and is editable on the basis of an ontology editor.

3. The system as claimed in claim 1, wherein the second ontology is described on the basis of OWL.

4. The system as claimed in claim 1, wherein the plant ontology comprises a structural ontology and a process ontology, wherein the structural ontology describes components of the plant and also the structural correlations thereof and the process ontology describes processes performed by the components of the plant.

5. The system as claimed in claim 1, wherein the user interface can additionally be used by a user to specify at least one of concepts and relations of the first ontology.

6. The system as claimed in claim 1, wherein the reasoner is additionally embodied such that it classifies the concepts in the second ontology and outputs the classification result via the user interface.

7. The system as claimed in claim 1, wherein the user interface is embodied such that a user can direct queries to the second ontology, the query results being output via the user interface, wherein the queries are preferably SPARQL queries.

8. The system as claimed in claim 1, wherein the rule generator is embodied such that it first of all generates rules in the RIF-XML serialization syntax and subsequently translates the rules of this syntax into the executable rules of the format of the rule engine into the Etalis format.

9. A method for the computer-aided creation of rules for at least one of monitoring and diagnosing a technical plant by a system comprising: —providing a digital knowledge base in the form of a first ontology, which includes a plant ontology, which describes the technical plant on the basis of concepts and relations, and a rule ontology, which includes rules as concepts, wherein a respective rule is linked by a condition relation to concepts in the form of one or more conditions, wherein the condition or conditions refer to one or more concepts of the plant ontology and wherein a respective rule is linked by a consequence relation to the concept of a consequence that is derived from the condition(s) and that refers to one or more concepts of the plant ontology; —providing a user interface, whereby a user can alter the rule ontology by specifying rules, whereby the first ontology is edited; —applying, a reasoner to a second ontology, which is derived from the first edited ontology by an ontology transformer or which is the first edited ontology, wherein the reasoner verifies the rules in the second ontology and outputs the verification result via the user interface; —and generating executable rules with a rule generator which generates executable rules from the first edited ontology, which executable rules can be executed by a rule engine.

10. A method for at least one of monitoring and diagnosing a technical plant, wherein executable rules are created by providing a system as claimed in claim 1 and are executed by a rule engine during the operation of the technical plant.

11. An apparatus for at least one of monitoring and diagnosing a technical plant, wherein the apparatus is set up to carry out the method as claimed in claim 10.

12. A computer program product having a program code, which is stored on a machine-readable storage medium, for performing a method as claimed in claim 9 when the program code is executed on a computer.
